(19) United States
(12) Patent Application Publication
(10) Pub. No.: US 2014/0179224 A1
(43) Pub. Date: Jun. 26, 2014

(54) WATCH HAVING NFC ANTENNA

(71) Applicant: HON HAI PRECISION INDUSTRY CO., LTD., New Taipei (TW)

(72) Inventor: KUANG-YAO LIAO, New Taipei (TW)

(73) Assignee: HON HAI PRECISION INDUSTRY CO., LTD., New Taipei (TW)

(21) Appl. No.: 13/873,137

(22) Filed: Apr. 29, 2013

(30) Foreign Application Priority Data
Dec. 21, 2012 (TW) 101148905

(51) Int. Cl. G04G 21/04; H01Q 7/00

(52) U.S. Cl. CPC G04G 21/04; H01Q 7/00
USPC 455/41.1

(57) ABSTRACT

A watch having a near field communication (NFC) antenna includes a display screen, and a printed circuit board (PCB). The display screen has a first surface and an opposite second surface. The PCB is attached on the first surface of the display screen. The NFC antenna includes a number of concentrically wound coils attached on the second surface of the display screen.

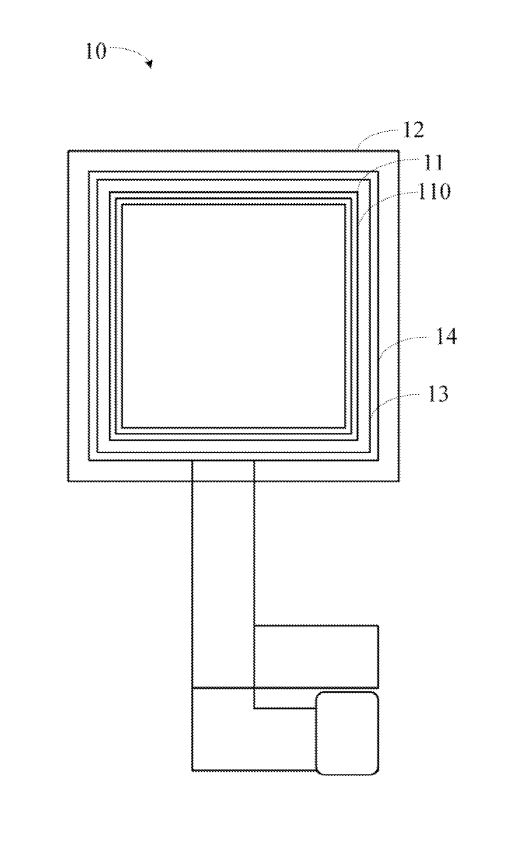

### BACKGROUND

1. Technical Field

The present disclosure relates to watches having antennas and particularly to a watch having a near field communication antenna.

2. Description of the Related Art

Nowadays, watches having near field communication (NFC) antennas are very popular. However, the NFC antennas employed in the watches occupy a lot of space. Furthermore, electrical elements disposed on a PCB of the watch may cause electrostatic interference with the NFC antenna.

Therefore, there is room for improvement within the art.

### BRIEF DESCRIPTION OF THE DRAWINGS

The components in the drawing are not necessarily drawn to scale, the emphasis instead being placed upon clearly illustrating the principles of the disclosure. Moreover, in the drawing, like reference numerals designate corresponding parts throughout the several views.

The FIGURE is a schematic plan view of a NFC antenna of a watch, in accordance with an exemplary embodiment.

### DETAILED DESCRIPTION

Referring to the FIGURE, a watch 10 includes a near field communication (NFC) antenna 11, a display screen 12, and a printed circuit board (PCB) 13. The NFC antenna 11 includes a plurality of concentrically wound coils 110 with coil sizes changing gradually. In the embodiment, each of the plurality of coils 110 is rectangular. In an alternative embodiment, each of the plurality of coils 110 is circular. The display screen 12 is configured to display time, date, and so on.

The plurality of coils 110 are disposed on a surface of the display screen 12, around the display screen 12. The display screen 12 has another surface opposite to the surface where the coils 110 are disposed that is pasted to the PCB 13.

The watch 10 further includes a shielding frame 14 surrounding the display screen 12. The shielding frame 14 is configured to separate the plurality of coils 110 from a metal frame (not shown) of the watch 10. The display screen 12 is sandwiched between the NFC antenna 11 and the PCB 13, which shields the NFC antenna 11 from electrical elements (not shown) disposed on the PCB 13, resulting in reduced electrostatic interference therebetween.

In the embodiment, the PCB 13 is a flexible printed circuit board (FPC).

It is understood that the present disclosure may be embodied in other forms without departing from the spirit thereof. The present examples and embodiments are to be considered in all respects as illustrative and not restrictive, and the disclosure is not to be limited to the details given herein.

What is claimed is:

1. A watch comprising:
a display screen having a first surface and an opposite second surface;
a printed circuit board (PCB) attached on the first surface of the display screen; and
a NFC antenna comprising a plurality of concentrically wound coils attached on the second surface of the display screen.

2. The watch as recited in claim 1, wherein each of the plurality of coils is rectangular.

3. The watch as recited in claim 1, wherein the PCB is a flexible printed circuit board.

4. The watch as recited in claim 1, wherein the plurality of coils are disposed around the display screen.

5. The watch as recited in claim 4, further comprising a metal frame and a shielding frame disposed around the display screen, the shielding frame configured to separate the plurality of coils away from the metal frame.
